(19) United States
(12) Patent Application Publication
(10) Pub. No.: US 2025/0057135 A1
(43) Pub. Date: Feb. 20, 2025

(54) FISHING REEL AND FISHING GEAR

(71) Applicant: GUANGDONG COROS SPORTS TECHNOLOGY CO., LTD, Dongguan (CN)

(72) Inventors: Haotian NIU, Dongguan (CN); Yu TANG, Dongguan (CN); Hongbo XU, Dongguan (CN)

(21) Appl. No.: 18/925,589

(22) Filed: Oct. 24, 2024

Related U.S. Application Data
(63) Continuation of application No. PCT/CN2022/094606, filed on May 24, 2022.

(51) Int. Cl. A01K 89/015; A01K 87/00; A01K 97/12

(52) U.S. Cl. CPC A01K 89/01931; A01K 87/007; A01K 97/125

(57) ABSTRACT

A fishing reel includes a body frame, a spool, an acceleration detector, a braking device, and one or more processors. The spool is rotatably arranged at the body frame and configured to wind a fishing line. The acceleration detector is configured to detect a line release acceleration of the fishing line. The braking device is configured to apply resistance to the spool. The one or more processors are connected to the acceleration detector and the braking device and configured to control the braking device to apply the resistance to the spool according to the line release acceleration to cause a rotation speed of the spool to match a line release speed of the fishing line.

### CROSS-REFERENCE TO RELATED APPLICATION

The present application is a continuation of International Application No. PCT/CN2022/094606, filed May 24, 2022, the entire content of which is incorporated herein by reference.

### TECHNICAL FIELD

The present disclosure generally relates to the angling device technology field and, for example, to a fishing reel and fishing gear.

### BACKGROUND

Lure fishing is a fishing method that triggers a big fish to attack by simulating a small prey. This fishing method requires a combined operation of a rod, bait, and fishing reel. Throughout the process, an angler is engaged in a full-body exercise, which is highly enjoyable and increasingly popular among anglers.

Typically, a lure fishing reel includes a body frame, a spool, a drive mechanism, and a transmission mechanism. The spool is rotatably mounted at the body frame. The transmission mechanism is configured to realize transmission between the drive mechanism and the spool. The transmission mechanism includes a clutch. When the clutch is in driving connection with the spool, the drive mechanism drives the spool to rotate through the clutch to wound the fishing line onto the spool. When the clutch is disengaged with the spool, the spool rotates freely to release the fishing line from the spool.

When the fishing reel is used, the bait is attached to an end of the fishing line. After the bait is cast, the bait can pull the fishing line from the spool to move with the bait. Meanwhile, the fishing line drives the spool to rotate at a high speed to allow the fishing line to be released quickly from the spool. However, when the bait falls into water, the moving speed of the bait reduces rapidly, and the line release speed of the fishing line also correspondingly reduces rapidly. However, the spool still rotates at a high speed due to inertia, causing the speed at which the spool rotates to release the fishing line to be far greater than the line release speed of the fishing line. Thus, the fishing line is cumulated at the spool to cause the released fishing line to be reversely wound at the spool to cause the fishing line to be twisted and tangled, i.e., causing a backlash problem in the fishing reel.

To address the above problem, an operation method includes, after the bait is cast, observing the movement of the bait and pressing the spool by using the finger to brake the spool when the bait falls into the water to prevent the backlash. However, the operation method highly relies on the experience of the angler, and for an angler not familiar with the fishing reel or a novice angler, the operation method is difficult to realize.

Thus, a fishing reel and fishing gear are needed to solve the above technical problem.

### SUMMARY

In accordance with the disclosure, there is provided a fishing reel including a body frame, a spool, an acceleration detector, a braking device, and one or more processors. The spool is rotatably arranged at the body frame and configured to wind a fishing line. The acceleration detector is configured to detect a line release acceleration of the fishing line. The braking device is configured to apply resistance to the spool. The one or more processors are connected to the acceleration detector and the braking device and configured to control the braking device to apply the resistance to the spool according to the line release acceleration to cause a rotation speed of the spool to match a line release speed of the fishing line.

In accordance with the disclosure, there is provided a fishing reel including a body frame, a spool, a first speed detector, a second speed detector, a braking device, and one or more processors. The spool rotatably is arranged at the body frame and configured to wind a fishing line. The first speed detector is configured to detect a line release speed of the fishing line and includes a photoelectric detector or a Doppler detector. The second speed detector is configured to detect a rotation speed of the spool. The braking device is configured to apply resistance to the spool. The one or more processors are connected to the first speed detector, the second speed detector, and the braking device, and configured to control the braking device to apply the resistance to the spool according to the line release speed and the rotation speed of the spool to cause the rotation speed of the spool to match the line release speed of the fishing line.

In accordance with the disclosure, there is provided a fishing reel control method. The method includes detecting a line release acceleration of a fishing line wound at a spool of a fishing reel and controlling a braking device of the fishing reel to apply resistance to the spool according to the line release acceleration to cause a rotation speed of the spool to match a line release speed of the fishing line.

In accordance with the disclosure, there is provided a fishing reel control method. The method includes detecting a line release speed of a fishing line wound at a spool of a fishing reel, detecting a rotation speed of the spool, and controlling a braking device of the fishing reel to apply resistance to the spool according to the line release speed and the rotation speed to cause the rotation speed of the spool to match the line release speed of the fishing line.

### BRIEF DESCRIPTION OF THE DRAWINGS

FIG. 1 is a schematic structural diagram of a fishing gear according to some embodiments of the present disclosure.

FIG. 2 is a schematic structural diagram of a fishing reel according to some embodiments of the present disclosure.

FIG. 3 is a schematic structural diagram of another fishing reel according to some embodiments of the present disclosure.

FIG. 4 is a schematic structural diagram of another fishing reel according to some embodiments of the present disclosure.

FIG. 5 is a schematic structural diagram of another fishing reel according to some embodiments of the present disclosure.

FIG. 6 is a schematic structural diagram of a guide member according to some embodiments of the present disclosure.

FIG. 7 is a schematic flowchart of a fishing reel control method according to some embodiments of the present disclosure.

FIG. 8 is a schematic structural diagram of another fishing reel according to some embodiments of the present disclosure.

FIG. 9 is a schematic structural diagram of another fishing reel according to some embodiments of the present disclosure.

FIG. 10 is a schematic structural diagram of another fishing reel according to some embodiments of the present disclosure.

FIG. 11 is a schematic structural diagram of another fishing reel according to some embodiments of the present disclosure.

FIG. 12 is a schematic structural diagram of another fishing reel according to some embodiments of the present disclosure.

FIG. 13 is a schematic flowchart of another fishing reel control method according to some embodiments of the present disclosure.

### REFERENCE NUMERALS

Reference numerals:

| | | |
|---|---|---|
| 1 Fishing rod | 11 Fishing rod body | 12 Guide ring |
| 2 Fishing reel | 21 Body frame | 23 Drive assembly |
| 24 Transmission | 25 Guide member | 26 Guide hole |
| assembly | | |
| 252 Groove | 26 Support rod | 27 Acceleration detector |
| 271 First speed | | 272 Second speed detector |
| detector | | |
| 281 Power supply | 282 Coil | 283 Permanent magnet |
| 29 Processor | | |

### DETAILED DESCRIPTION OF THE EMBODIMENTS

The technical solution of the present disclosure is described in detail in connection with the accompanying drawings. The embodiments are merely used to describe the present disclosure. To facilitate description, the accompanying drawings only show part, but not necessarily all, of the present disclosure.

In some embodiments, the terms “connected,” “coupled,” and “fixed” should be broadly interpreted. For example, the connection can be a fixed connection, a detachable connection, or an integration; a mechanical connection or an electrical connection; or a direct connection, an indirect connection through an intermedium, or an internal communication or an interaction relationship of two elements intermediaries; or communication or interaction between two components. For those skilled in the art, the meanings of the terms of the present disclosure can be understood based on the above terms.

In the present disclosure, a first feature being “on” or “under” a second feature can include the first feature directly contacting the second feature, or the first feature not directly contacting the second feature but the first feature contacting the second feature through another feature. Moreover, the first feature being “on,” “above,” and “over” the second feature can include the first feature being right above and diagonally above the second feature, or merely a horizontal height of the first feature being higher than a horizontal height of the second feature. The first feature being “below,” “under,” and “lower than” the second feature can include the first feature is right under and diagonally under the second feature or the horizontal height of the first feature being smaller than the horizontal height of the second feature.

In the description of embodiments of the present disclosure, the terms “up,” “bottom,” “right,” etc., are based on the orientation or position shown in the accompanying drawings to facilitate description and simplify operation, and do not imply or indicate that the device or element must have a certain orientation or is constructed or operated with a certain orientation. In addition, the terms “first” and “second” are merely used to distinguish in the description and do not have a special meaning.

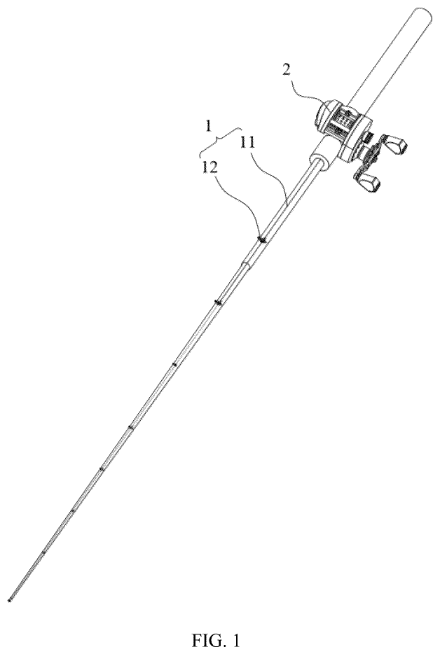

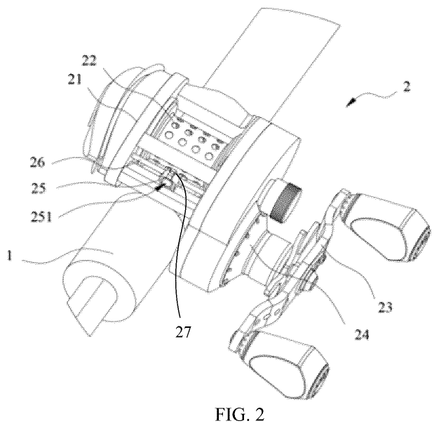

Embodiments of the present disclosure provide a fishing reel and fishing gear. As shown in FIG. 1 and FIG. 2, the fishing gear includes a fishing rod 1 and a fishing reel 2. The fishing reel 2 is arranged at one end of the fishing rod 1. In some embodiments, the length of the fishing rod 1 can be retractable, and the retractable structure and principle are not limited here. The fishing reel 2 includes a body frame 21 and a spool 22. The body frame 21 can be fixed at one end of the fishing rod 1, and the spool 22 is rotatably arranged at the body frame 21. The fishing rod 1 includes a rod body 11 and a plurality of guide rings 12 arranged at the length direction of the rod body 11 at intervals. An end of the fishing line is wound at the spool 22. The other end passes through the plurality of guide rings 12 in sequence to be connected to the bait. The fishing reel 2 further includes a drive assembly 23 and a transmission assembly 24. The drive assembly 23 is arranged at the body frame 21. The transmission assembly 24 includes a clutch. An output end of the drive assembly 23 is connected to the clutch. When the clutch is transmission-engaged with the spool 22, the drive assembly 23 can drive the spool 22 to rotate relative to the body frame 21 to wind the fishing line onto the spool 22. When the clutch is disengaged with the spool 22, the spool 22 can rotate relative to the body frame 21 under an external force. For example. When the angler casts the fishing line connected to the bait. The fishing line can drive the spool 22 to rotate to release the fishing line from the spool 22. The structures of the drive assembly 23 and the transmission assembly 24 are not limited here.

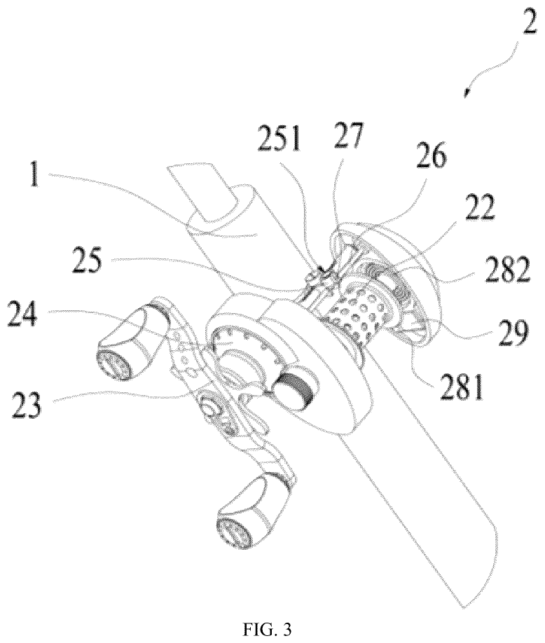

In some embodiments, as shown in FIG. 2 and FIG. 3, the fishing reel 2 further includes an acceleration detector 27, a braking device, and a processor 29. In the examples shown in drawings and the embodiments described below, one processor 29 is depicted and described. The present disclosure, however, is not limited thereto. For example, the fishing reel 2 can include one or more processors collectively or individually configured to perform a method consistent with the disclosure.

The acceleration detector 27 is configured to detect the line release acceleration of the fishing line, i.e., the acceleration at which the fishing line is being released. The braking device is configured to apply resistance to the spool 22. The processor 29 is configured to control the braking device to apply the resistance to the spool 22 according to the line release acceleration detected by the acceleration detector 27 to cause the rotation of the spool 22 to match the line release speed of the fishing line, i.e., the speed at which the fishing line is being released.

The processor of the fishing reel 2 of embodiments of the present disclosure can accurately determine the moment when the bait connected to the end of the fishing line falls into the water according to the detection result of the acceleration detector and perform braking on the spool 22 at the moment when the bait falls into the water to quickly reduce the release speed of the spool 22 for the fishing line to cause the rotation speed of the spool 22 (the release speed of the spool 22 for the fishing line) to match the line release speed of the fishing line to effectively prevent the backlash problem for the fishing reel 2. The fishing gear of the present disclosure can automatically determine a braking moment for the spool 22 after the bait is cast through the fishing reel 2 to brake the spool 22 without relying on the experience of the angler. Thus, the operation of casting the bait can be simple, and the fishing gear can be suitable for anglers with different fishing levels.

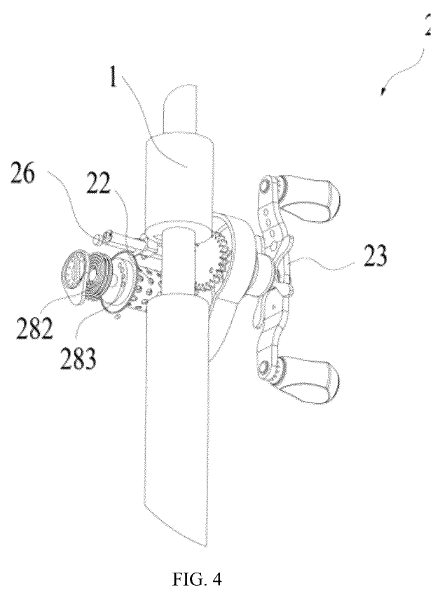

In some embodiments, as shown in FIG. 3 and FIG. 4, the braking device includes a power supply 281, a coil 282, and a permanent magnet 283. When the power supply 281 supplies power to the coil 282, the coil 282 can generate a magnetic field. The permanent magnet 283 is arranged at the spool 22. When the spool 22 rotates, the permanent magnet 283 can cut through the magnetic field lines generated by the coil 282. Thus, the magnetic field generated by the coil 282 can generate resistance for the permanent magnet and the spool 22 to brake the spool 22. The magnitude of the resistance of the magnetic field generated by the coil 282 to the spool 22 can be controlled by controlling the current through the coil 282. In other embodiments, the braking device can be a mechanical braking device, for example, a brake pad structure, which is not limited here.

In some embodiments, the processor 29 can set a preset acceleration range. When the line release acceleration is outside the preset acceleration range, the processor 29 can control the braking device to apply resistance to the spool 22. After the angler casts the bait, the bait and the fishing line can be subjected to gravity, air resistance, and friction resistance of the guide rings 12 to cause the line release acceleration of the fishing line to remain within a range (i.e., the preset acceleration range). When the bait falls into the water, the bait can be subjected to the resistance of the water, and the line release acceleration can abruptly change. Then, the line release acceleration detected and output by the acceleration detector 27 can be outside the preset acceleration range. After the processor 29 receives the line release acceleration outside the preset acceleration range, the processor 29 can determine that the bait falls into the water and control the braking device to apply resistance to the spool 22 to cause the rotation speed of the spool 22 to match the line release speed of the fishing line to prevent the backlash problem.

In some other embodiments, the processor 29 can set a preset acceleration change amount range. The processor 29 can determine the line release acceleration change amount according to the line release acceleration. When the line release acceleration change amount is outside the preset acceleration change amount range, the processor 29 can control the braking device to apply resistance to the spool 22. After the angler casts the bait, the bait and the fishing line can be subjected to gravity, air resistance, and friction resistance of the guide ring 12 to cause the line release acceleration change amount of the fishing line to remain in a range (i.e., the preset acceleration change amount range). When the bait falls into the water, the bait can be subjected to the resistance of the water, and the line release acceleration can abruptly have a significant change. Then, the acceleration detector 27 can detect the line release acceleration. After the processor 29 receives the line release acceleration and determines the line release acceleration change amount being outside the preset acceleration change amount range, the processor 29 can determine that the bait falls into the water and control the braking device to apply resistance to the spool 22 to cause the rotation speed of the spool 22 to match the line release speed of the fishing line to prevent the backlash problem.

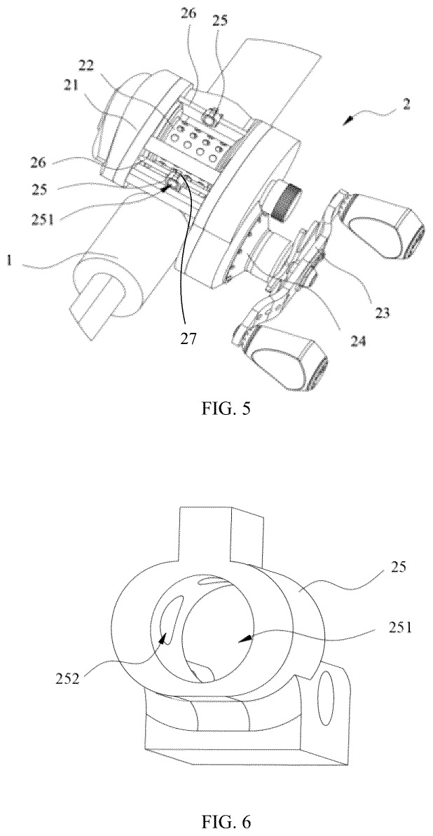

In some embodiments, as shown in FIG. 2, FIG. 3, and FIG. 5, the fishing reel 2 also includes at least one guide member 25. Each guide member 25 includes a guide hole 251. The fishing line sequentially passes through the guide holes 251 of all the guide members 25. A corresponding acceleration detector 27 is arranged at each guide member 25. The acceleration detector 27 can detect the line release acceleration of the fishing line at the corresponding guide hole 251. The guide member 25 can guide the extension direction of the fishing line and also provide a detection position for the acceleration detector 27 to ensure that the acceleration or the acceleration change amount of the fishing line is accurately detected. In some embodiments, the acceleration detector 27 can be arranged in the guide ring 12 at the fishing rod 1.

In some embodiments, as shown in FIG. 2 and FIG. 3, the fishing reel 2 includes a guide member 25. The guide member 25 includes an acceleration detector 27. Thus, the fishing reel 2 includes only one acceleration detector 27, which outputs one detection result. The processor 29 can control the braking device 28 to apply resistance to the spool 22 according to the detection result.

In some embodiments, the fishing reel 2 can include one guide member 25, and the guide member 25 includes at least two acceleration detectors. As such, the fishing reel 2 can include the at least two acceleration detectors, which can output at least two detection results. The processor 29 can first process the at least two detection results and then control the braking device to apply resistance to the spool 22 in response to the processed detection results.

In some embodiments, as shown in FIG. 5, the fishing reel 2 includes at least two guide members 25, and each guide member 25 of the at least two guide members 25 includes an acceleration detector 27. Thus, the fishing reel 2 includes the at least two acceleration detectors 27, which can output at least two detection results. The processor 29 can first process the at least two detection results and then control the braking device to apply resistance to the spool 22 in response to the processed detection results.

In some embodiments, the fishing reel 2 can include at least two guide members 25. Each guide member 25 can include at least two acceleration detectors 27. Thus, the fishing reel 2 can include a plurality of (at least four) acceleration detectors 27, which can output a plurality of detection results. The processor 29 can first process the plurality of detection results and then control the braking device to apply resistance to the spool 22 according to the processed results.

When at least two acceleration detectors 27 are provided, the processor 29 can select some or all of the detection results from all the acceleration detectors 27 and calculate a first detection result average value according to the detection results and compare the first detection result average value to the preset detection result range. When the first detection result average value is outside of the preset detection result range, the processor 29 can control the braking device to apply resistance to the spool 22 to improve the accuracy of the detection result responded by the processor 29. Thus, the accuracy of the timing of the braking device to apply resistance to the spool 22 can be improved to better prevent the backlash problem.

When the detection result output by the acceleration detector 27 is the line release acceleration, the first detection result average value can be an average value of the plurality of line release accelerations. The preset detection result range can be the preset acceleration range. The first detection result average value can also be an average value of the plurality of line release acceleration change amounts. Then, the preset detection result range can be the preset acceleration change amount range.

In some embodiments, when two acceleration detectors 27 are provided, the processor 29 can select the detection results from the two acceleration detectors 27 and calculate the first detection result average value. That is, the first detection result average value can be an average value of the line release accelerations of the two acceleration detectors 27 or the average value of the line release acceleration change amounts of the two acceleration detectors 27. When a plurality of acceleration detectors 27 are provided, the processor 29 can select the detection results of all the acceleration detectors 27 and calculate the average value of the first detection results. That is, the first detection result average value can be the average value of the line release accelerations of the plurality of acceleration detectors or the average value of the line release acceleration change amounts of the plurality of acceleration detectors. When a plurality of acceleration detectors 27 are provided, the processor 29 can remove a largest result and/or a smallest result in the detection results of the plurality of acceleration detectors 27. Then, the first detection result average value can be calculated according to the detection results of the remaining acceleration detectors 27. Then, the first detection result average value can be an average value of the line release accelerations of a part of the acceleration detectors 27 or an average value of the line release acceleration change amount of a part of the acceleration detectors 27.

The number of guide members 25, the number of acceleration detectors 27, and the preset detection result range can be set as needed and are not limited here.

As shown in FIG. 5, in some embodiments, the fishing reel 2 includes two guide members 25. The two guide members are set at the body frame 21. In some embodiments, the body frame 21 includes a support rod 26. The support rod 26 can extend along the axial direction of the spool 22 and can be arranged with the spool 22 at an interval. The guide member 25 is arranged at the support rod 26 and can slide along the support rod 26. When the fishing line is wound at the spool 22, the fishing line is wound at the spool 22 along the circumferential direction of the spool 22. Each layer of fishing line is sequentially arranged along the axial direction of the spool 22. Thus, when the fishing line is released, the fishing line can swing back and forth along the axial direction of the spool 22. In embodiments of the present disclosure, the guide member 25 can be configured to slide along the support rod 26 to cause the guide member 25 to swing along the axial direction of the spool 22 with the fishing line synchronously to reduce the resistance of the guide member 25 to the fishing line to ensure the moving acceleration of the fishing line at the guide member 25 to be consistent with the line release acceleration of the fishing line released from the spool 22. Thus, the detection result of the acceleration detector 27 can accurately reflect the line release acceleration of the fishing line. The accuracy of the timing for the braking device to brake can be improved. In some other embodiments, the number of the guide members 25 may not be limited, and the guide member 25 can be partially arranged at the body frame 21 and partially arranged at the fishing rod 1.

In some embodiments, the acceleration detector 27 can include a photoelectric detector or a Doppler detector.

The photoelectric detector can include a first emitter and a first receiver. The first emitter can emit light to the fishing line in the guide hole 251 of the guide member 25 where the photoelectric detector is located. The first receiver can receive the light reflected by the fishing line in the guide hole 251 of the guide member 25 where the photoelectric detector and calculate the current line release acceleration of the fishing line. The first emitter can emit a detection signal at a preset frequency. Meanwhile, the first receiver can receive a signal reflected by the fishing line at the preset frequency. The photoelectric detector can correspondingly calculate the line release speed of the fishing line according to the position relationship of a same marked point reflected by four received neighboring reflection signals. The photoelectric detector can also correspondingly calculate the line release acceleration of the fishing line according to the position relationship of the same marked point reflected by eight received neighboring reflection signals. The watermark, dust, and dirt can be used as marked points when the photoelectric detector performs calculations. Since the marked points of the fishing line normally exist, the marked points can be used to detect the line release speed of the transparent fishing line.

The Doppler detector can include a second emitter and a second receiver. The second emitter can emit a pulse signal toward the fishing line inside the guide hole 251 of the guide member 25 where the Doppler detector is located. The second receiver can receive the pulse signal reflected by the fishing line inside the guide hole 251 of the guide member 25 where the Doppler detector is located and calculate the line release acceleration of the fishing line.

In some embodiments, when the fishing line is made of transparent material, the signal emitted by the first emitter and/or the second emitter can be a signal with a wavelength band that ensures the highest reflectivity of the fishing line material to ensure that the strength of the reflection signal correspondingly received by the first receiver and the second receiver is better. The wavelength bands of the signals emitted by the first emitter and the second emitter can be set according to the fishing line material. In some embodiments, the fishing line material can be a transparent material. The acceleration detector 27 can be the photoelectric detector. The light emitted by the first emitter can be invisible light.

In some embodiments, the inner wall of the guide hole 251 can be coated with a coating. The coating can absorb the light emitted by the first emitter and/or the pulse signal emitted by the second emitter to prevent interference to the signal reflected by the fishing line by the reflected light or pulse signal of the inner wall of the guide member 25 to further ensure the accuracy of the detection result of the acceleration detector 27. In some embodiments, the coating can be a selective wave-absorbing coating, which can absorb the light emitted by the first emitter or the pulse signal emitted by the second emitter. The coating can be black ink (can absorb visible light), ferrite coating, ceramic coating, polymer coating, polycrystalline iron fiber coating, nano-coating, etc. The coating can be selected according to the wavelength bands of the signals emitted by the first emitter and the second emitter, which is not limited here.

In some embodiments, as shown in FIG. 6, grooves 252 are formed at the inner wall of the guide hole 251. The photoelectric detector and the Doppler detector are accommodated within the grooves 252. The grooves 252 can protect the photoelectric detector and Doppler detector from contamination by dust, impurities, etc. to ensure the light and the signal are received and emitted smoothly. When an acceleration detector 27 is arranged at the guide member 25, a groove 252 is formed at the inner wall of the guide hole 251. When two or more acceleration detectors 27 are formed at the guide member 25, a corresponding number of grooves 252 are formed at the inner wall of the guide hole 251.

In some embodiments, the line release acceleration of the fishing line may only need to be detected. Based on the comparison between the detected line release acceleration and the preset detection result range, the timing of the bait falling into the water can be directly determined, and the braking device can be controlled to brake in time to prevent backlash. In the anti-backlash solution of embodiments of the present disclosure, only the detection result of one moving parameter of the fishing line can be relied on, the reliability can be high, and the cost can be low.

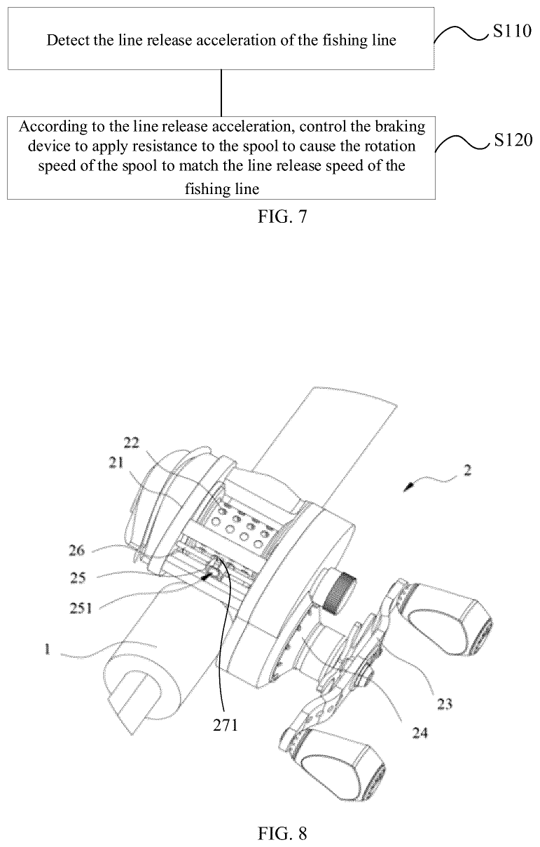

As shown in FIG. 7, the present disclosure provides a fishing reel control method. The fishing reel includes a body frame, a spool, and a braking device. The spool is rotatably arranged at the body frame. The spool can be configured to wind the fishing line. The braking device can be configured to apply resistance to the spool. The method can be performed by the control device of the fishing reel. The control device of the fishing reel can be arranged in the fishing reel and can be used as a part of the fishing reel. As shown in FIG. 7, the control method of the fishing reel of the present disclosure includes the following processes.

At S110, the line release acceleration of the fishing line is detected.

In some embodiments, the acceleration detector can detect the line release acceleration of the fishing line.

At S120, according to the line release acceleration, the braking device is controlled to apply resistance to the spool to cause the rotation speed of the spool to match the line release speed of the fishing line.

In some embodiments, the processor can be connected to the acceleration detector. The processor can control the braking device to apply resistance to the spool according to the line release acceleration detected by the acceleration detector to cause the rotation speed of the spool to match the line release speed of the fishing line.

In some embodiments, the acceleration detector and the processor can be arranged in the fishing reel as the control devices.

In some embodiments, controlling the braking device to apply the resistance to the spool according to the line release acceleration can include controlling the braking device to apply the resistance to the spool in response to the line release acceleration being outside the preset acceleration range.

In some embodiments, the method can further include determining the line release acceleration change amount according to the line release acceleration.

Controlling the braking device to apply resistance to the spool according to the line release acceleration can include when the line release acceleration change amount is outside the preset acceleration change amount range, controlling the braking device to apply resistance to the spool.

The principle and technical effects of the fishing reel control method of embodiments of the present disclosure can be the same as the principle and the technical effect of the fishing reel of embodiments of the present disclosure. For specific principles and technical effects, reference can be made to the fishing reel of embodiments of the present disclosure.

Embodiments of the present disclosure provide a fishing reel and fishing gear. As shown in FIG. 1 and FIG. 8, the fishing gear includes a fishing rod 1 and a fishing reel 2. The fishing reel 2 is arranged at an end of the fishing rod 1. In some embodiments, the length of the fishing rod 1 can be retractable, and the retractable structure and principle are not limited here. The fishing reel 2 includes a body frame 2 and a spool 22. The body frame 21 is fixed at an end of the fishing rod 1. The spool 22 is rotatably arranged at the body frame 21. The fishing rod 1 includes a rod body 11 and a plurality of guide rings 12 arranged along the length direction of the rod body 11 at intervals. An end of the fishing line is wound at the spool 22, and the other end of the fishing line passes through the plurality of guide rings 12 to be connected to the bait. The fishing reel 2 further includes a drive assembly 23 and a transmission assembly 24. The drive assembly 23 is arranged at the body frame 21. The transmission assembly 24 includes a clutch. The output end of the drive assembly 23 is connected to the clutch. When the clutch transmission-cooperates with the spool 22, the drive assembly 23 can drive the spool 22 to rotate relative to the body frame 21 to wind the fishing line onto the spool 22. When the clutch 23 does not transmission-cooperate with the spool 22, the spool 22 can rotate relative to the body frame 21 under an external force. For example, when the angler casts the fishing line connected to the bait, the bait can drive the spool 22 to rotate to release the fishing line from the spool 22. The structures of the drive assembly 23 and the transmission assembly 24 are not limited here.

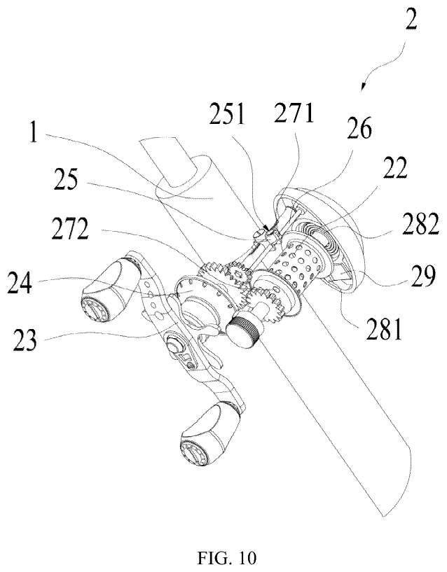

In some embodiments, as shown in FIGS. 8-10, the fishing reel 2 further includes a first speed detector 271, a second speed detector 272, a braking device, and a processor 29. The first speed detector 271 can be configured to detect the line release speed of the fishing line. The first speed detector 271 can include a photoelectric detector or a Doppler detector. The second speed detector 272 can be configured to detect the rotation speed of the spool 22. The braking device can be configured to apply resistance to the spool 22. The processor 29 can be configured to control the braking device to apply the resistance to the spool 22 according to the detection results of the first speed detector 271 and the second speed detector 272 to match the rotation speed of the spool 22 with the line release speed of the fishing line.

The processor 29 of the fishing reel 2 of embodiments of the present disclosure can accurately determine the moment when the bait connected to the end of the fishing line falls into the water according to the detection results of the first speed detector 271 and the second speed detector 272. The processor 29 can cause the braking device to brake the spool 22 when the bait falls into the water to quickly reduce the line release speed of the spool 22 to the fishing line to match the rotation speed of the spool 22 (the release speed of the spool to the fishing line) with the line release speed of the fishing line to effectively prevent the backlash of the fishing reel 2. The fishing gear of the present disclosure can automatically determine the braking moment to the spool after the bait is cast and perform braking through the fishing reel 2 without relying on the experience of the angler. Thus, the operation process of casting the bait can be more convenient, and the fishing gear can satisfy anglers with different fishing skills.

The processor 29 can set a preset difference range. The first speed detector 271 can output the line release speed of the fishing line, and the second speed detector can output the rotation speed of the spool 22. When the difference between the line release speed and the rotation speed of the spool 22 is outside the preset difference range, the processor 29 can control the braking device to apply resistance to the spool 22. Before the angler casts the bait and the bait falls into the water, the line release speed can match the rotation speed of the spool 22. That is, the line release speed can be the same as the rotation speed or can have only a small difference with the rotation speed. When the bait falls into the water, the speed of the bait can be quickly decreased. The line release speed of the fishing line connected to the bait can be correspondingly decreased. However, the rotation speed of the spool 22 can remain unchanged due to inertia. Since the difference between the rotation speed of the spool 22 and the line release speed of the fishing line can abruptly increase and exceed the preset difference range, the processor 29 can determine that the bait falls into the water and control the braking device to apply resistance to the spool 22. Thus, the rotation speed of the spool 22 can match the line release speed of the fishing line to prevent the back backflash.

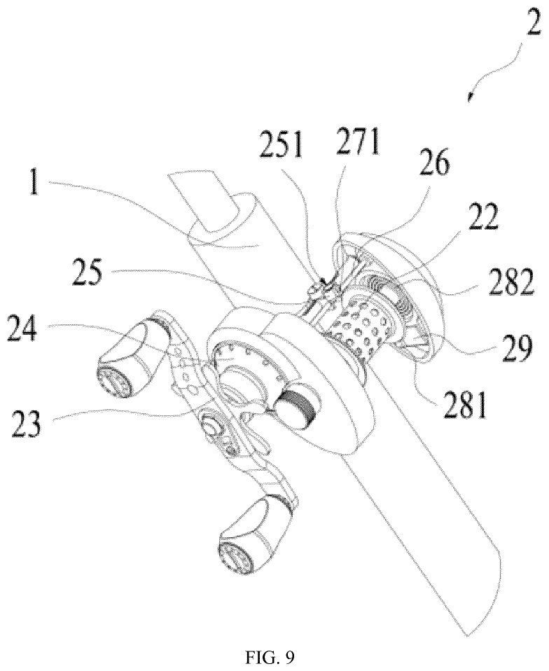

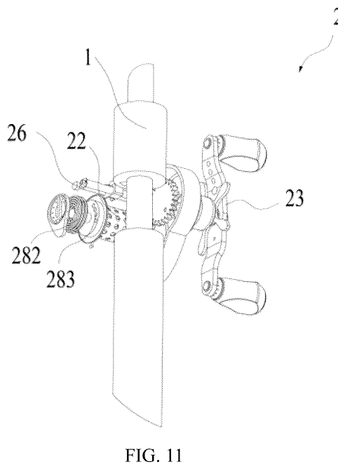

In some embodiments, as shown in FIGS. 9-11, the braking device includes a power supply 281, a coil 282, and a permanent magnet 283. When the power supply 281 supplies power to the coil 282, the coil 282 generates a magnetic field. The permanent magnet 283 is arranged at the spool 22. When the spool 22 rotates, the permanent magnet 283 cuts the magnetic field lines generated by the coil 282, causing the magnetic field generated by the coil 282 to produce resistance to the permanent magnet 283 and the spool 22, thereby achieving braking of the spool 22. It is understood that the specific magnitude of the resistance produced by the magnetic field of the coil 282 to the spool 22 can be controlled by adjusting the current supplied to the coil 282. Of course, in other embodiments, the braking device 28 can also be mechanical braking, such as a brake pad structure, which is not limited here.

In some embodiments, as shown in FIGS. 8-12, the fishing reel 2 further includes at least one guide member 25. Each guide member 25 includes a guide hole 251, and the fishing line passes sequentially through the guide holes 251 of all the guide members 25. Each guide member 25 correspondingly includes a first speed detector 271, which can detect the line release speed of the fishing line at the corresponding guide hole 251. The guide members 25 can guide the extension direction of the fishing line and also provide a detection position for the first speed detector 271, ensuring the accurate detection of the line release speed of the fishing line.

In some embodiments, the processor 29 can control the braking device to apply resistance to the spool 22 according to the average value of the detection results of some or all of the first speed detectors 271 and the detection result of the second speed detector 272. By averaging the line release speeds detected by the plurality of first speed detectors 271, the accuracy of the line release speed used for the calculation can be ensured, and the calculation results of the line release speed and the line release speed of the fishing line can have high accuracy. Thus, the accuracy of the moment in which the braking device applies the resistance to the spool 22 can be improved, and the backlash problem can be better prevented.

In some other embodiments, the processor 29 can control the braking device to apply resistance to the spool 22 according to the minimum detection result of the detection results of the plurality of first speed detectors 271 and the detection result of the second speed detector 272. That is, as long as the minimum line release speed that is detected matches the rotation speed of the spool 22, the line release speed of the fishing line may not be smaller than the rotation speed of the spool 22 (i.e., the release speed of the spool 22 to the fishing line). Thus, the backlash problem may not occur. In some embodiments, the first speed detector 271 can also be arranged in the guide ring 12 of the fishing rod 1.

In some embodiments, as shown in FIGS. 8-10, the fishing reel 2 includes a guide member 25. The guide member 25 includes a first speed detector 271. Thus, the fishing reel 2 includes one first speed detector 271, which can output one line release speed of the fishing line. Then, the processor 29 can calculate the difference between the line release speed detected by the first speed detector 271 and the rotation speed of the spool 22 detected by the second speed detector 272, and compare the difference with the preset difference range. When the difference is outside the preset difference range, the processor 29 can control the braking device to apply resistance to the spool 22.

In some embodiments, the fishing reel 2 can include one guide member 25. The guide member 25 can include at least two first speed detectors 271. Thus, the fishing reel 2 can include at least two first speed detectors 271, and can output at least two line release speeds. Then, the processor 29 can select some or all of the line release speeds detected by the at least two first speed detectors 271, calculate the average value of the second detection results according to the selected line release speeds, calculate then the difference between the average value of the second detection results and the detection result of the second speed detector 272, and compare the difference to the preset difference range. When the difference is outside the preset difference range, the braking device 28 can be controlled to apply the resistance to the spool 22.

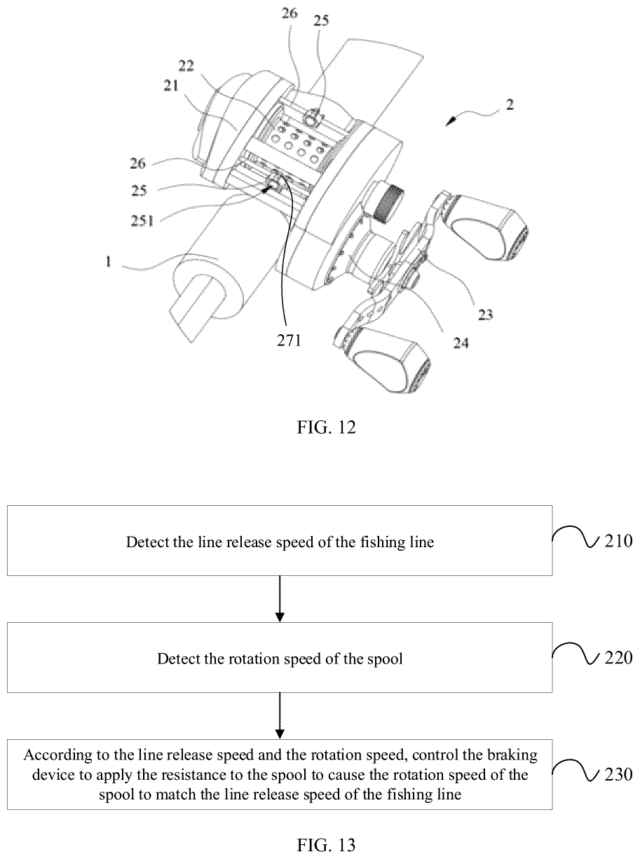

In some embodiments, as shown in FIG. 12, the fishing reel 2 includes at least two guide members 25. Each guide member 25 includes one first speed detector 271. Thus, the fishing reel 2 includes at least two first speed detectors 271, which can output at least two line release speeds. Then, the processor can select some or all of the line release speeds detected by the at least two first speed detectors 271, calculate the average value of the second detection results according to the selected line release speeds, calculate the difference between the average value of the second detection result and the detection result of the second speed detector 272, compare the difference with the preset difference range, and control the braking device to apply resistance to the spool 22 when the difference is outside the preset difference range.

In some embodiments, the fishing reel 2 includes at least two guide members 25, and each guide member 25 includes at least two first speed detectors 271. Thus, the fishing reel 2 includes a plurality of first speed detectors 271, and can output a plurality of line release speeds. Then, the processor 29 can select some or all of the line release speeds detected by the plurality of first speed detectors 271, calculate the average value of the second detection result according to the selected line release speeds, compare the difference with the preset difference range, and control the braking device to apply resistance to the spool 22 when the difference is outside the preset difference range.

According to different numbers of the first speed detectors 271, the processor 29 calculating the average value of the second detection result can include any one of the following methods. When two first speed detectors 271 are provided, the processor 29 can select the line release speeds detected by the two first speed detectors 271 and calculate the average value to obtain the average value of the second detection result. When a plurality of first speed detectors 271 are provided, the processor 29 can select the line release speeds detected by the plurality of first speed detectors 271 and calculate the average value to obtain the average value of the second detection result. When a plurality of first speed detectors 271 are provided, the processor 29 can remove the maximum and/or minimum line release speed of the line release speeds detected by the plurality of first speed detectors 271 and calculate the average value of the remaining line release speeds detected by the first speed detectors 29 to obtain the average value of the second detection result.

The number of guide members 25, the number of first speed detectors 271, and the method for calculating the average value of the second detection result can be selected and set by those skilled in the art according to actual needs and are not specifically limited herein.

As shown in FIG. 12, in some embodiments, the fishing reel 2 includes two guide members 25. The two guide members 25 are arranged at the main body frame 21. In some embodiments, the body frame 21 includes a support rod 26. The support rod 26 extends along the axial direction of the spool 22 and is arranged at an interval with the spool 22. The guide members 25 are arranged at the support rod 26 and can slide along the support rod 26. When the fishing line is wound at the spool 22, the fishing line can be wound at the spool 22 along a circumferential direction of the spool 22, and each layer of the fishing line can be arranged in sequence along the axial direction of the spool 22. Thus, when the fishing line is released, the fishing line can move back and forth along the axial direction of the spool 22. The guide members 25 of embodiments of the present disclosure can slide along the support rod 26. Thus, guide members 25 can move along the axial direction of the spool 22 synchronously with the fishing line to reduce the assistance of the guide members 25 to the fishing line, which ensures that moving speed of the fishing line at the guide members 25 is consistent with the line release speed when the fishing line is released from the spool 22. Thus, the detection result of the first speed detector 271 can accurately represent the line release speed of the fishing line to improve the accuracy of the timing when the braking device 28 performs braking. In some other embodiments, the number of first detectors 28 is not limited. The guide members 25 can be partially arranged at the body frame 21 and partially arranged at the fishing rod 1.

In some embodiments, the first speed detector 271 can include a photoelectric detector and/or a Doppler detector.

In some embodiments, the photoelectric detector can include a first emitter and a first receiver. The first emitter can emit light toward the fishing line located in the guide hole 251 of the guide member 25 where the photoelectric detector is located. The first receiver can receive the light reflected by the fishing line in the guide hole 251 of the guide member 25 where the photoelectric detector is located and calculate the current line release speed of the fishing line. The first emitter can emit a detection signal at a preset frequency, while the first receiver can receive the signal reflected by the fishing line at the preset frequency. The photoelectric detector can correspondingly calculate the line release speed of the fishing line according to the position change amount of the same marked point reflected by two neighboring reflection signals that are received. The water stains, dust, dirt, etc., on the fishing line can be used as marking points for the calculation of the photoelectric detector. The marked points on the fishing line can inevitably exist and can be suitable for the detection of the line release speed of the transparent fishing line.

The Doppler detector can include a second emitter and a second receiver. The second emitter can emit pulse signals toward the fishing line located in the guide hole 251 of the guide member 25 where the Doppler detector is located, and the second receiver can receive the pulse signals reflected by the fishing line in the guide hole 251 of the guide member 25 where the Doppler detector is located and calculate the line release speed of the fishing line.

In some embodiments, when the fishing line is made of the transparent material, the signals emitted by the first emitter and/or the second emitter can be a signal with a wavelength band to cause the material of the fishing line to have the highest reflectivity. Thus, the reflection signals correspondingly received by the first receiver and the second receiver can be ensured to have a better strength. The wavelength band of the signal emitted by the first emitter and the second emitter can be selected according to the material of the fishing line. In embodiments of the present disclosure, the fishing line can be made of the transparent material. The first speed detector 271 can be the photoelectric detector, and the light emitted by the first emitter can be invisible light.

In some embodiments, the inner wall of the guide hole 251 can be coated with a coating. The coating can absorb the light emitted by the first emitter and/or the pulse signal emitted by the second emitter to prevent the inner wall of the guide member 25 from reflecting the light or pulse signals to disturb the signal reflected by the fishing line. Thus, the accuracy of the detection result of the first speed detector 271 can be ensured. In some embodiments, the coating can be a selective wave-absorbing coating, which can be used to absorb the light emitted by the first emitter or the pulse signal emitted by the second emitter. The coating can be black ink (capable of absorbing visible light), ferrite coating, ceramic coating, polymer coating, polycrystalline iron fiber coating, nano-coating, etc. The coating can be selected according to the wavelength band of the signals emitted by the first emitter and the second emitter, which is not limited here.

In some embodiments, as shown in FIG. 6, a groove 252 is formed at the inner wall of the guide hole 251. The photoelectric detector and/or the Doppler detector can be accommodated within the groove 252. The groove 252 can protect the photoelectric detector and the Doppler detector to prevent the dust, impurities, and other substances from contaminating the photoelectric detector and the Doppler detector to ensure the smooth transmission and reception of the light and the signals. When one first speed detector 271 is arranged at the guide member 25, one groove 252 can be formed at the inner wall of the guide member 251. When two or more first speed detectors 271 are arranged at the guide member 25, the corresponding number of grooves 252 can be formed at the inner wall of the guide hole 251.

As shown in FIG. 13, the present disclosure provides a fishing reel control method. The fishing reel includes the body frame, the spool, and the braking device. The spool can be rotatably arranged at the body frame. The spool can be configured to wind the fishing line. The braking device can be configured to apply resistance to the spool. The method can be performed by the fishing reel control device. The fishing reel control device can be arranged in the fishing reel as a part of the fishing reel. As shown in FIG. 13, the fishing reel control method of the present disclosure can include the following processes.

At S210, the line release speed of the fishing line is detected.

For example, the first speed detector can detect the line release speed of the fishing line.

At S220, the rotation speed of the spool is detected.

For example, the second speed detector can detect the rotation speed of the spool.

At S230, according to the line release speed and the rotation speed, the braking device is controlled to apply the resistance to the spool to cause the rotation speed of the spool to match the line release speed of the fishing line.

For example, the processor can be connected to the first speed detector and the second speed detector. The processor can control the braking device to apply resistance to the spool to cause the rotation speed of the spool to match the line release speed.

For example, the first speed detector, the second speed detector, and the processor can be arranged in the fishing reel as the fishing reel control device.

The principle and the technical effect of the fishing reel control method of embodiments of the present disclosure are the same as the principle and the technical effect of the fishing reel of embodiments of the present disclosure. For the specific principle and technical effect, reference can be made to the fishing reel of embodiments of the present disclosure.

What is claimed is:

1. A fishing reel comprising:
a body frame;
a spool rotatably arranged at the body frame and configured to wind a fishing line;
an acceleration detector configured to detect a line release acceleration of the fishing line;
a braking device configured to apply resistance to the spool; and
one or more processors connected to the acceleration detector and the braking device, and configured to control the braking device to apply the resistance to the spool according to the line release acceleration to cause a rotation speed of the spool to match a line release speed of the fishing line.

2. The fishing reel according to claim 1, wherein the one or more processors are further configured to:
in response to the line release acceleration being outside a preset acceleration range, control the braking device to apply the resistance to the spool.

3. The fishing reel according to claim 1, wherein the one or more processors are further configured to:
determine a change amount of the line release acceleration; and
in response to the change amount being outside a preset acceleration change amount range, control the braking device to apply the resistance to the spool.

4. The fishing reel according to claim 1, further comprising:
one or more guide members each including a guide hole configured for the fishing line to pass through;
wherein:
the acceleration detector is one of one or more acceleration detectors of the fishing reel, each arranged at one of the one or more guide members and configured to detect the line release acceleration of the fishing line at the guide hole of the corresponding guide member; and
the one or more processors are configured to control the braking device to apply the resistance to the spool according to an average value of line release accelerations output by at least one of the one or more acceleration detectors.

5. The fishing reel according to claim 1, wherein the acceleration detector includes a photoelectric detector or a Doppler detector.

6. The fishing reel according to claim 1, wherein the acceleration detector includes:
a signal emitter configured to emit a signal with a wavelength band in which a material of the fishing line has a highest reflectivity.

7. The fishing reel according to claim 6, further comprising:
a guide member including a guide hole configured for the fishing line to pass through;
wherein:
the acceleration detector is arranged at the guide member; and
an inner wall of the guide hole is coated with a coating configured to absorb the signal emitted by the signal emitter.

8. The fishing reel according to claim 6, further comprising:
a guide member including a guide hole configured for the fishing line to pass through;
wherein:
a groove is formed at an inner wall of the guide hole; and
the acceleration detector is arranged in the groove.

9. A fishing gear comprising:
a fishing rod; and
the fishing reel according to claim 1 mounted at the fishing rod.

10. A fishing reel comprising:
a body frame;
a spool rotatably arranged at the body frame and configured to wind a fishing line;
a first speed detector configured to detect a line release speed of the fishing line and including a photoelectric detector or a Doppler detector;
a second speed detector configured to detect a rotation speed of the spool;
a braking device configured to apply resistance to the spool; and
one or more processors connected to the first speed detector, the second speed detector, and the braking device, and configured to control the braking device to apply the resistance to the spool according to the line release speed and the rotation speed of the spool to cause the rotation speed of the spool to match the line release speed of the fishing line.

11. The fishing reel according to claim 10, wherein the one or more processors are further configured to:
in response to a difference between the line release speed and the rotation speed of the spool being outside a preset difference range, control the braking device to apply the resistance to the spool.

12. A fishing gear comprising:
a fishing rod; and
the fishing reel according to claim 10 mounted at the fishing rod.

13. A fishing reel control method comprising:
detecting a line release acceleration of a fishing line wound at a spool of a fishing reel; and
controlling a braking device of the fishing reel to apply resistance to the spool according to the line release acceleration to cause a rotation speed of the spool to match a line release speed of the fishing line.

14. The method according to claim 13, wherein controlling the braking device to apply the resistance to the spool includes:
in response to the line release acceleration being outside a preset acceleration range, controlling the braking device to apply the resistance to the spool.

15. The method according to claim 13, further comprising:
determining a change amount of the line release acceleration;
wherein controlling the braking device to apply the resistance to the spool includes:
in response to the change amount being outside a preset acceleration change amount range, controlling the braking device to apply the resistance to the spool.

16. A fishing reel control method comprising:
detecting a line release speed of a fishing line wound at a spool of a fishing reel;
detecting a rotation speed of the spool; and
controlling a braking device of the fishing reel to apply resistance to the spool according to the line release speed and the rotation speed to cause the rotation speed of the spool to match the line release speed of the fishing line.

17. The method according to claim 16, wherein controlling the braking device to apply the resistance to the spool includes:
in response to a difference between the line release speed and the rotation speed being outside a preset difference range, controlling the braking device to apply the resistance to the spool.
